(19) United States
(12) Patent Application Publication
(10) Pub. No.: US 2010/0298194 A1
(43) Pub. Date: Nov. 25, 2010

(54) Cleaning composition for tankless water heater

(76) Inventors: Eva Ackerman, Houston, TX (US); Yanwei Cen, Houston, TX (US); Prakash Patel, Houston, TX (US)

Correspondence Address: Yanwei Cen, 2601 Spenwick, Houston, TX, 77055, US

(21) Appl. No.: 12/454,608

(22) Filed: May 20, 2009

(51) Int. Cl. C02F 5/08

(52) U.S. Cl. 510/247

(57) ABSTRACT

A composition useful in cleaning of a tankless water heater system. The composition contains mixture of organic and inorganic acids. The composition may further contain phosphates and corrosion inhibitors.

### FIELD OF THE INVENTION

This invention generally relates to a solid cleaning composition for the tankless water heater system. The composition contains a mixture of organic and inorganic acids.

### BACKGROUND OF THE INVENTION

The most common water heater used today is a water heater having a storage tank. In this, a supply or tank of water is pre-heated by an electric heating element or combustion of fossil fuel so that hot water is available shortly after a hot-water spigot is opened. Storage-tank water heaters waste energy in that there is substantial energy lost by radiation and conduction of the hot water stored in their storage tank, sometimes 40 or 50 gallons. The radiated energy also taxes air conditioning systems.

Recently, tankless, heaters have been deployed for heating water on demand. There are several major advantages in tankless water heaters. The first is, because there is no pre-heated water, there is very little energy loss due to heat radiated from the pre-heated water. Second, the tankless water heaters are smaller, requiring fewer raw materials and requiring fewer resources in shipment. Third, the tankless water heaters occupy less space in homes, apartments, retail outlets, warehouses etc.

Over prolonged usage, the tankless water heater becomes contaminated with suspended solids, sludge, mineral deposits, and other debris and particulates. Such contaminants can reduce the operating efficiency of the system. The system requires regular maintenance and flushing of the unit with a cleaning or flushing composition in order to remove these contaminants.

Most of the composition used as cleaning or flushing compositions in the prior art is food grade vinegar. The common food grade vinegar contains about 5 percent of acetic acid and 95 percent of water. This aqueous solution is introduced into the tankless water heater through its service port, dislodging the mineral and other deposits within the tankless water heater. This composition is widely available and thus widely used in the field. However, it is relatively slow and not very efficient.

Diluted hydrochloric acid solution is also used to clean the tankless water heater. Its high corrosives property may damage internal parts of the tankless water heater, causing plastic cracking, o-ring deforming, or metal rusting.

Both compositions are in liquid form that is heavy for transportation and prone to leak in storage. There is a need for a cleaning composition that is in solid form at room temperature for the easy shipping and safe storage. There is also a need for an improved cleaning composition that removes contaminants from the tankless water heater and does not damage the internal parts of the tankless water heater.

### SUMMARY OF THE INVENTION

The present invention is directed to a composition useful in cleaning of the tankless water heater. The composition contains a combination of organic acid, inorganic acid, and corrosion inhibitors. In a particularly preferred embodiment, the invention relates to a composition containing a solid organic acid at room temperature, containing no more than eight carbon atoms, and an inorganic acid at room temperature. The composition may further contain alkali metal phosphates.

### DETAILED DESCRIPTION OF THE INVENTION

The inventive cleaning composition contains a mixture of organic acids, inorganic acids, corrosion inhibitors, and other components, which are in solid form at room temperature.

The inventive cleaning composition contains at least one organic acid containing no more than eight carbon atoms.

The organic acid for use in the invention preferably contains from 1 to about 8 carbon atoms. The organic acid further preferably is of high purity, i.e., at least 98 weight percent. Further preferred are lower purity organic acids such as those containing 94 to 97 weight percent.

Preferred as the organic acid for use in the invention are malic acid, malonic acid, maleic acid, fumaric acid, lactic acid, gluconic acid, succinic acid and citric acid. A particularly preferred organic acid is maleic acid and citric acid. The amount of organic acid useful in the composition is between from about 1 to about 30, preferably between 1 to about 10, weight percent of the composition.

The cleaning composition of the invention further contains at least one inorganic acid that is in solid form at room temperature. A preferred inorganic acid are boric acid and sulfamic acid. A particularly preferred organic acid is sulfamic acid. The amount of inorganic acid useful in the composition is between from about 70 to about 99, preferably between 70 to about 99, weight percent of the composition.

The composition of the invention may further contain up to about 20 weight percent of corrosion inhibitor that is in solid form at room temperature. Preferred corrosion inhibitors are sodium meta borate, ammonium thiocyanate, sodium silicate borax, sodium nitrate, and amine based substances.

The cleaning composition of the invention may further contain a surface conditioner that is in solid form at room temperature. Preferred surface conditioners are alkali metal phosphates, such as sodium phosphate, sodium polyphosphate, potassium polyphosphate. When present, the amount of phasphate is generally no greater than about 5, preferably between from about 0.01 to less than about 2, weight percent.

The cleaning composition of the invention may further contain a stabilizer that is in solid form at room temperature. Preferred stabilizer is ethylene diamine tetra-acetic acid (EDTA). When present, the amount of stabilizer is generally no greater than about 3, preferably between from about 0.01 to less than about 2, weight percent.

Further, the cleaning composition of the invention may further contain an indicator such as pH indicator. When employed, the amount of indicator is generally less than one weight percent.

The cleaning composition of the invention can be added into the tankless water heater at room temperature, or at elevated temperatures. The method in which the cleaning composition is used in the heater depends, in part, upon the size of the system being cleaned. For small heaters, the cleaning composition may be dissolved in clean water and feed into the heater using a hand-operated pump. For larger tankless water heater systems, a circulating pump or a submersible pump may be used. The cleaning composition of the invention may be gradually added into the recirculating water.

The following examples show the preparation and use of the cleaning composition of the invention and is offered for illustrative purposes and not intended to limit or define the invention in any manner:

### EXAMPLE 1

40 grams of maleic acid and 100 grams of boric acid and 10 grams of EDTA are mixed are blended in a kitchen blender for 30 seconds. The blended mixture is white powder and odor less. Its appearance density is 1.2 grams per cubic centimeter.

### EXAMPLE 2

10 grams of citric acid, 100 grams of sulfamic acid, 2 grams of EDTA, 5 grams of sodium polyphosphate are hand mixed in a beaker. The mixture is white and odor less and its appearance density is 1.3 grams per cubic centimeter. The mixture is then dissolved in 2000 grams of water at room temperature. The solution is clear and has a pH at less than 2.

### EXAMPLE 3

10 grams of citric acid, 400 grams of sulfamic acid, 2 grams of EDTA, 5 grams of sodium polyphosphate are mixture in a beaker. The mixture is then dissolved in 8000 grams of water at room temperature. The solution is clear and has a pH at less than 2. The solution is pumped through a Bosch tankless water heater for 30 minutes. Scale debris were pumped out of the unit. The water efficiency reestablished.

### EXAMPLE 4

A gas fired tankless water heater (Pro Tankless GWH 425 HN, manufactured by Bosch) was in service for several years. The user complained that the water flow was low and the water from the heater was not hot enough. The water heater was isolated from the service and its cold water inlet and hot water outlet were connected to a submersible pump using plastic hoses and hose clamps. The pump was placed in a 5 gallon bucket containing 2 gallons of clean water and switched on for water circulation. A cleaning composition containing 512 grams of sulfamic acid, 53 grams of citric acid, 19 grams of O'hibit, 17 grams of sodium polyphosphate, 8 grams of EDTA was added to the 5 gallon bucket. The water became cloudy and a lot yellowish solids were carried out through the pump. After 40 minutes cleaning, the water flow of the heater was increased and the water outlet temperature reached 145 degree Fahrenheit.

Although the present invention and its advantages have been described in detail, it should be understood that various changes, substitutions, and alterations could be made herein without departing from the spirit and scope of the invention as defined by the appended claims.

1. A cleaning composition for tankless water heater system, the composition being in solid form at room temperature, wherein the composition comprises:
(a) from about 1 to about 5 weight percent of at least one organic acid having 1 to 6 carbon atoms;
(b) from about 80 to about 99 weight percent of an inorganic acid.

2. The cleaning composition of claim 1, further comprising from about 0.01 to about 5 weight percent of a corrosion inhibitor.

3. The cleaning composition of claim 2, wherein the corrosion inhibitor is amine, phosphates.

4. The cleaning composition of claim 1, wherein the organic acid is formic acid, acetic acid.

5. The cleaning composition of claim 1, wherein the organic acid is citric acid.

6. The cleaning composition of claim 1, wherein the inorganic acid is sulfamic acid.

7. (canceled)

8. (canceled)

9. The cleaning composition of claim 1, further containing alkali phosphate or alkali polyphosphates.

10. The cleaning composition of claim 1, further containing sodium polyphosphates.

11. The cleaning composition of claim 1, further comprising EDTA.

12. A cleaning composition for the tankless water heater comprising:
(a) about 1 to about 5 weight percent of an organic acid containing 1-6 carbon atoms;
(b) about 80 to about 99 weight percent of an inorganic acid, and
(c) about 0.01 to about 5 weight percent of corrosion inhibitor.

13. The composition of claim 12, wherein the organic acid is citric acid.

14. The composition of claim 12, wherein the inorganic acid is sulfamic acid.

15. The composition of claim 12, wherein the corrosion inhibitor is the O′B hibit manufactured by Zinkan Enterprises Incorporated.

16. The composition of claim 12, further comprising sodium polyphosphates.

17. The composition of claim 12, further comprising EDTA.

18. A cleaning composition for tankless water heater system, the composition being in solid form at room temperature, wherein the composition comprises:
(a) from about 1 to about 5 weight percent of a citric acid;
(b) from about 1 to about 5 weight percent of a sodium polyphosphates;
(d) from about 80 to about 99 weight percent of sulfamic acid;
(e) from 0.01 to about 5 weight percent of a corrosion inhibitor;
(f) from 0.01 to about 5 weight percent of a EDTA.

19. A method for cleaning tankless water heater systems comprising:
(a) preparing a cleaning solution by dissolving the cleaning composition of claim 1 in water,
(b) circulating the cleaning solution through the inlet and outlet of a tankless water heater system using an electric pump or hand pump.

20. The cleaning solution of claim 19 comprises:
(a) from about 1 to about 25 weight percent of cleaning composition of claim 1,
(b) from about 75 to about 99 weight percent of water.
